(19) United States
(12) Patent Application Publication
(10) Pub. No.: US 2021/0398074 A1
(43) Pub. Date: Dec. 23, 2021

(54) TERMINAL CONTROL SYSTEM AND METHOD

(71) Applicant: Transportation IP Holdings, LLC, Norwalk, CT (US)

(72) Inventors: Srinivas Bollapragada, Niskayuna, NY (US); Jian Li, Melbourne, FL (US); Albert Mary Henry Stoffels, Austin, TX (US); John Baxley, Rockwall, TX (US); Aguru Niranjan, Atlanta, GA (US); Victor Andres Diaz Romero, Atlanta, GA (US)

(21) Appl. No.: 17/446,976

(22) Filed: Sep. 6, 2021

Related U.S. Application Data
(63) Continuation-in-part of application No. 15/339,060, filed on Oct. 31, 2016, now Pat. No. 11,110,945.
(60) Provisional application No. 62/308,922, filed on Mar. 16, 2016.

(51) Int. Cl. G06Q 10/08; B66C 13/48; B66C 13/40; B66C 13/00; B65G 63/00

(52) U.S. Cl. CPC G06Q 10/08355; B66C 13/48; B66C 19/007; B66C 13/00; B65G 63/004; B66C 13/40

(57) ABSTRACT

A system includes one or more processors that determine: a characteristic of a cargo container scheduled for receipt into or travel out of a terminal; a characteristic of cargo handling equipment associated with the terminal and selected from cranes, lifts, conveyors, and elevators; a characteristic of a first transportation vehicle scheduled for entry into or travel out of the terminal; a characteristic of a different, second transportation vehicle scheduled for entry into or travel out of the terminal; a constraint associated with cargo handling operations involving transferring the cargo container via the cargo handling equipment; and a plan for the cargo handling equipment to transfer the cargo container within the terminal based on the characteristics and the constraint. The one or more processors initiate the cargo handling equipment to move the cargo container from the first transportation vehicle to the second transportation vehicle according to the plan.

### CROSS-REFERENCE TO RELATED APPLICATIONS

This application is a continuation-in-part of U.S. Non-Provisional application Ser. No. 15/339,060, filed 31 Oct. 2016, which claims priority to U.S. Provisional Application No. 62/308,922, filed 16 Mar. 2016. The entire disclosures of both applications are incorporated herein by reference.

### BACKGROUND

### Technical Field

Embodiments of the disclosure may relate to intermodal terminals or yards, and systems for planning and/or controlling machinery within the terminals or yards.

### Discussion of Art

Intermodal containers are shipped using multiple modes of transport including truck, rail, ocean, and air. An intermodal railway terminal (or intermodal rail yard) is an interchange facility, providing the capability for rail carriers and their customers to transfer cargo units (containers and trailers) between different modes of transportation (e.g., between automobiles such as trucks and rail vehicles). These terminals include tracks for loading and unloading rail cars, container storage areas, and paved areas to support lifting equipment (e.g., cranes) and truck movements. A gate area similar to a toll booth is used to control access to the yard and log vehicles in and out.

Some planning, scheduling, and sequencing decisions have to be made in managing the yard. These decisions are currently made manually, leading to inefficiencies resulting in higher yard operating costs and lower throughputs. It may be desirable to have a system and method that differs from those that are currently available.

### BRIEF DESCRIPTION

In one or more embodiments, a system is provided that includes one or more processors that may determine at least one characteristic of at least one cargo container that is scheduled for one or more of receipt into or travel out of a terminal. The terminal is connected with different routes that may accommodate a plurality of differing transportation vehicles. The one or more processors may determine at least one characteristic of cargo handling equipment associated with the terminal. The cargo handling equipment is selected from cranes, lifts, conveyors, and elevators. The one or more processors may determine at least one characteristic of a first transportation vehicle of the plurality of differing transportation vehicles that is scheduled for one or more of entry into or travel out of the terminal. The first transportation vehicle is associated with a first mode of transportation. The one or more processors may determine at least one characteristic of a different, second transportation vehicle of the plurality of differing transportation vehicles that is scheduled for entry into or travel out of the terminal. The second transportation vehicle is associated with a different, second mode of transportation. The one or more processors may determine at least one constraint associated with cargo handling operations involving transferring the at least one cargo container from the first mode of transportation to the second mode of transportation via the cargo handling equipment. The one or more processors may determine a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations. The one or more processors are further configured to initiate the cargo handling equipment to move the at least one cargo container to transfer the at least one cargo container from the first transportation vehicle to the second transportation vehicle according to the plan.

In one or more embodiments, a system is provided that includes one or more processors configured to determine at least one characteristic of at least one cargo container that is scheduled for one or more of receipt into or travel out of a terminal. The terminal is connected with different routes configured to accommodate a plurality of differing transportation vehicles. The one or more processors may determine at least one characteristic of cargo handling equipment associated with the terminal. The cargo handling equipment is selected from cranes, lifts, conveyors, and elevators. The one or more processors may determine at least one characteristic of a first transportation vehicle of the plurality of differing transportation vehicles that is scheduled entry into the terminal. The first transportation vehicle is associated with a first mode of transportation. The one or more processors may determine at least one characteristic of a different, second transportation vehicle of the plurality of differing transportation vehicles that is scheduled for travel out of the terminal. The second transportation vehicle is associated with a different, second mode of transportation. The one or more processors may determine at least one constraint associated with cargo handling operations involving transferring the at least one cargo container from the first mode of transportation to the second mode of transportation. The one or more processors may determine a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the different, second transportation vehicle, and the constraint associated with the cargo handling operations. The one or more processors are further configured to initiate the cargo handling equipment to move the at least one cargo container to transfer the at least one cargo container from the first transportation vehicle to the second transportation vehicle according to the plan. The one or more processors may determine the plan in order to increase, relative to another, different plan for the terminal, one or more of: an efficiency metric of a total crane gantry distance of the cargo handling equipment, an efficiency metric of a total crane trolley distance of the cargo handling equipment, an efficiency metric of a total number of lifts of the at least one cargo container by the cargo handling equipment, an efficiency metric of a total idle time of the cargo handling equipment, an efficiency metric of a total driver waiting time of transportation vehicles associated with the second mode of transportation, and/or an efficiency metric of a number of the at least one cargo container that missed outbound departures of transportation vehicles associated with the first mode of transportation.

In one or more embodiments, a method is provided that includes determining at least one characteristic of at least one cargo container that is scheduled for one or more of receipt into or travel out of a terminal. The terminal is connected with different routes configured to accommodate a plurality of differing transportation vehicles. The method includes determining at least one characteristic of cargo handling equipment associated with the terminal. The cargo handling equipment is selected from cranes, lifts, conveyors, and elevators. The method includes determining at least one characteristic of a first transportation vehicle of the plurality of differing transportation vehicles that is scheduled for one or more of entry into or travel out of the terminal. The first transportation vehicle is associated with a first mode of transportation. The method includes determining at least one characteristic of a different, second transportation vehicle of the plurality of differing transportation vehicles that is scheduled for entry into or travel out of the terminal. The second transportation vehicle is associated with a different, second mode of transportation. The method includes determining at least one constraint associated with cargo handling operations involving transferring the at least one cargo container from the first mode of transportation to the second mode of transportation via the cargo handling equipment. The method includes determining a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations. The method further includes initiating the cargo handling equipment to move the at least one cargo container to transfer the at least one cargo container from the first transportation vehicle to the second transportation vehicle according to the plan.

### BRIEF DESCRIPTION OF THE DRAWINGS

The subject matter described herein will be better understood from reading the following description of non-limiting embodiments, with reference to the attached drawings, wherein below:

FIG. 1 illustrates one embodiment of a terminal;

FIG. 2 schematically illustrates one embodiment of a non-propulsion-generating vehicle;

FIG. 3 illustrates one embodiment of a terminal control system; and

FIG. 4 illustrates a swim lane diagram of one embodiment of operation of the control system.

### DETAILED DESCRIPTION

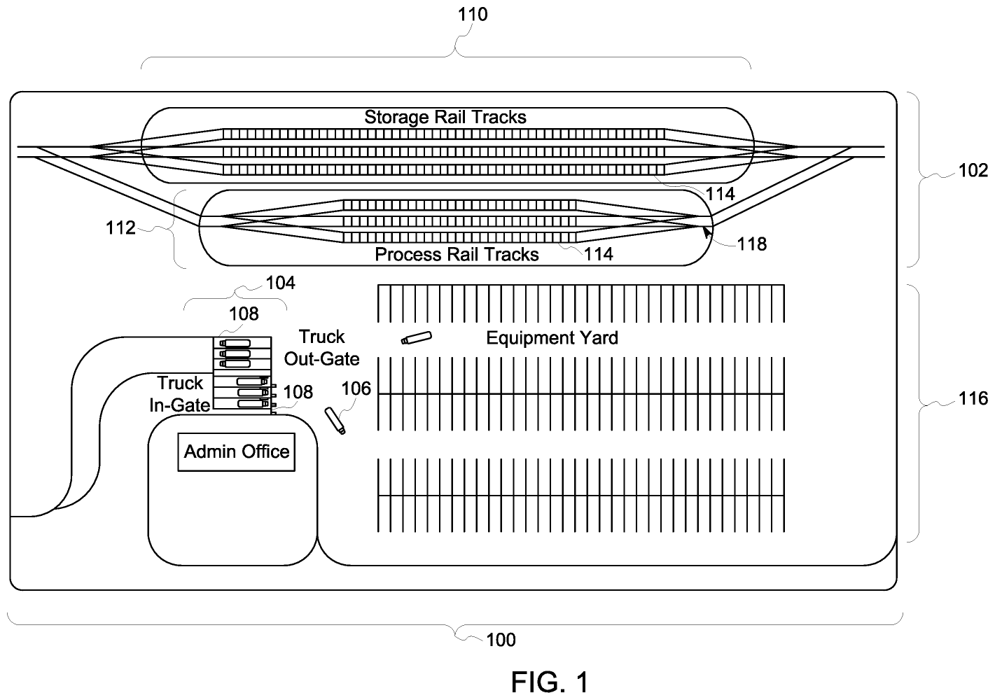

FIG. 1 illustrates one embodiment of a terminal 100 (e.g., transportation terminal). The terminal represents an interchange facility that provides the capability for rail carriers and customers to transfer cargo containers between different modes of transportation (e.g., truck and rail modes of transportation). The terminal includes one or more loading routes 102 (e.g., rail tracks, paved roads) and paved areas to support lifting equipment, truck movements, and storage areas. A gate area 104 is provided to control access to the terminal and log entry and exit of vehicles 106, such as over-the-road (OTR) trucks (e.g., referred to herein as OTR vehicles), in and out of the terminal. The gate area can include one or more gates 108 (“Truck In-Gate” and “Truck Out-Gate” in FIG. 1) that monitor entry and/or exit of the OTR vehicles, such as by automatically detecting passage of the OTR vehicles through a light beam using a light sensor (e.g., an infrared beam and sensor), through electromagnetic interrogation of radio frequency identification (RFID) tags on the OTR vehicles by RFID readers at the gates, manual logging of passage of the OTR vehicles, etc. The terminal may be referred to herein as an intermodal terminal.

In the intermodal terminal, the cargo containers are transferred between transportation vehicles associated with a first mode of transportation and transportation vehicles associated with a different, second mode of transportation. In a non-limiting example, the first mode of transportation is rail, such that the associated transportation vehicles are railcars of freight trains. The second mode of transportation may be road, such that the associated transportation vehicles are OTR trucks. Other suitable transportation modes may include marine and air modes. The cargo containers are brought into the terminal onboard incoming vehicle systems and exit the terminal onboard outgoing vehicle systems. For example, one or more cargo containers may enter the terminal on cargo-carrying cars (e.g., railcars) of a freight train. These vehicle systems include propulsion-generating vehicles (e.g., locomotives) that pull and/or push one or more non-propulsion-generating vehicles (e.g., railcars).

Each of the non-propulsion-generating vehicles can be associated with a unique identification. The one or more cargo containers may be removed from the cars by cargo handling equipment (CHE), such as cranes, lifts, hostlers, and/or the like. The one or more cargo containers may be directly moved to an OTR truck, and the OTR truck may exit the terminal with the one or more cargo containers onboard. Optionally, the one or more cargo containers may be indirectly transferred to the OTR truck by first storing the one or more cargo containers at an intermediate location in the terminal, such as on a trailer or at a designated storage location, for a time period until the OTR truck and/or the CHE equipment is ready to accept the one or more cargo containers. Although the example above describes the transfer of cargo containers from rail-based vehicles (e.g., trains) to road-based vehicles, the terminal may support direct and indirect transfer of cargo containers from road-based vehicles to rail-based vehicles.

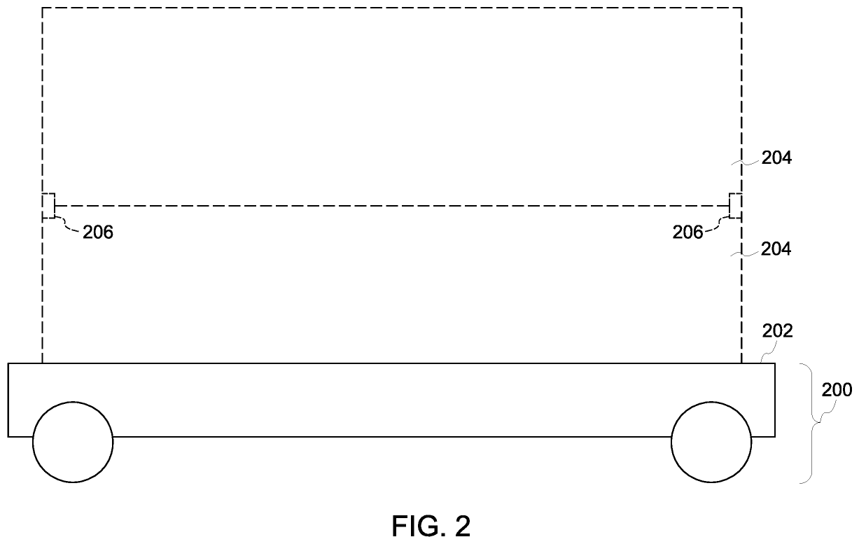

FIG. 2 schematically illustrates one embodiment of a non-propulsion-generating vehicle 200. The vehicle may be a cargo vehicle. The vehicle represents a platform or flatbed rail car having a series of wells or platforms 202 used to hold and secure containers and/or trailers 204 during transport. Many cargo vehicles have one or more wells or platforms. While the cargo vehicle shown in FIG. 2 includes one well, other cargo vehicles can have more than two wells. Each well can hold plural containers with only two being shown in FIG. 2. The containers may be secured together by inter-box connectors (IBCs) 206. Some or all of the incoming containers are unloaded at the terminal (shown in FIG. 1) to be picked up by customers using the vehicles. The cargo vehicles are then loaded with new containers and depart on outbound vehicle systems (e.g., trains) from the terminal.

Returning to the description of the intermodal terminal shown in FIG. 1, the terminal includes infrastructure and cargo handling equipment (CHE) to execute the transfer of cargo between the two modes of transportation (e.g., from truck-to-rail and/or rail-to-truck). The infrastructure includes one or more storage routes 110 (“Storage Rail Tracks” in FIG. 1) that may be a series of routes 114 (e.g., tracks, roads, etc.) used to receive rail vehicle systems arriving into the terminal from other intermodal terminals or locations, facilitate switching of the cargo vehicles within the rail vehicle systems among routes within the terminal to allow for moving and re-sequencing the order of cargo vehicles, stage or store the cargo vehicles until needed, to combine or build a vehicle system from one or more cargo vehicles and one or more propulsion-generating vehicles, etc. The terminal includes one or more processing routes 112 (“Process Rail Tracks” in FIG. 1) that are a series of routes used to unload the cargo containers from arriving cargo vehicles and/or load the cargo containers onto the cargo vehicles assigned to a departing vehicle system. One or more switches 118 represent intersections between the routes. These can be actuated to change which route a vehicle travels on after passing through a switch.

The gates of the intermodal terminal include a truck in-gate that is a checkpoint through which cargo containers are received into the intermodal terminal from the OTR vehicles planned (e.g., scheduled) for rail transport out of the intermodal terminal. Once the cargo container is interchanged (e.g., handed off or transferred from the OTR vehicle that then exits out of the terminal through the gate), legal responsibility for the cargo is transferred from the driver of the OTR vehicle to the rail carrier or owner of the rail vehicle system. The gates may include a truck out-gate that is a checkpoint through which cargo containers exit out of the terminal on authorized OTR vehicles. Once the cargo container is interchanged (e.g., left in the terminal for the OTR vehicle), legal responsibility for the cargo is transferred from the rail carrier to the driver of the OTR vehicle.

An equipment yard 116 of the terminal is a staging area for cargo containers, waiting to be loading onto a departing rail vehicle system or for pickup by an OTR vehicle to be delivered to a customer. The equipment yard can include designated parking spaces or areas where equipment and/or containers are placed onto trailers of the vehicles (e.g., platforms with wheels that support the containers, but that are not capable of self-propulsion) or on the ground. The terminal may include lifting equipment, such as cranes, used to load or unload cargo containers onto or from the vehicles. The lifting equipment may be used to mount or dis-mount containers onto or off of a trailer of the vehicles. The terminal may include yard vehicles or trucks, which are vehicles that move cargo containers between the equipment yard and the process rail routes. The CHE of the terminal includes cranes, grunts, hostlers, switches between routes, lifts, conveyors, elevators, or other machinery that operate to move the containers and other equipment.

A number of planning, sequencing, and scheduling decisions are made in managing the operations in the intermodal terminal. Making these decisions manually can result in inefficiencies such as larger than necessary travel distances for container handling equipment, larger than average numbers of lifts per container that is handled, larger than average driver turnaround time (e.g., the time required for a driver of an OTR vehicle to enter into the terminal drop off and/or pick up cargo containers, and exit out of the terminal), and/or larger numbers of cargo containers missing the scheduled departing rail vehicle systems. These efficiencies can lead to suboptimal yard throughput and higher than necessary operating costs. The yard throughput represents the rate at which containers are processed per unit time, such as the number of containers that are received into the terminal, transferred between modes of transportation, and exit out of the terminal per day.

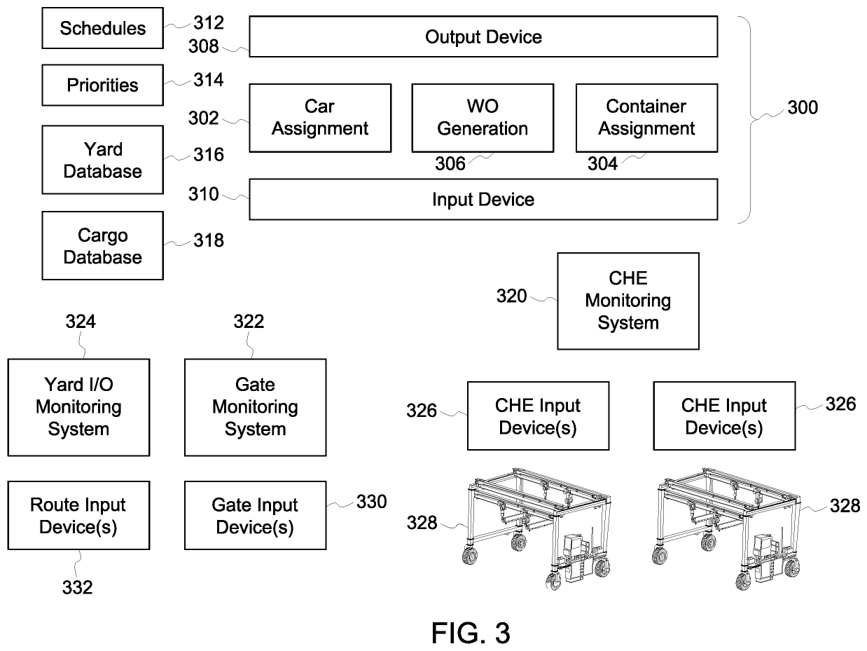

FIG. 3 illustrates one embodiment of a terminal control system 300. The control system may generate a plan to manage yard operations within the terminal. The plan may ensure that the yard throughput is maximized or increased (relative to performing yard operations in another order, performing different operations, and/or performing operations at different times) while efficiently using terminal resources. The plans may be referred to as a yard or intermodal plan, and can dictate schedules for operations to be performed in the terminal, such as when and/or where containers are to be moved, when and/or where vehicles are to move, when and/or where rail vehicle systems are to move within the terminal, etc. The control system creates the plans to enable freight railroads to efficiently manage the intermodal terminals used by the railroads by maximizing or increasing (relative to performing yard operations in another order, performing different operations, and/or performing operations at different times) the number of containers processed per unit time (e.g., per day), while meeting other goals of the terminal.

These additional goals that are met include one or more of planning so that rail vehicle systems arrive into the terminal and depart the terminal on time (e.g., at scheduled times), cargo containers that arrive on the inbound rail vehicle systems are available for pickup by the OTR vehicles on time (e.g., at or no later than scheduled times), cargo containers arriving into the terminal before a cut off or closing time of the gate make an outbound rail vehicle system, driver turn time to be less than a upper limit time period.

The control system creates the plan for a terminal to meet (e.g., achieve) several different yard goals. These goals include one or more of having at least a designated amount (e.g., all, 90%, 80%, etc.) of vehicle systems arriving into the terminal and/or departing from the terminal on schedule, at least a designated amount (e.g., all, 90%, 80%, etc.) of cargo containers that arrive on the inbound vehicle systems being available for pickup by the OTR vehicles on time, at least a designated amount (e.g., all, 90%, 80%, etc.) of cargo containers that arrive before a gate cut off time being on an outbound rail vehicle system, and/or the driver turn time of the OTR vehicles to be less than a designated upper time period.

Some goals sought to be achieved by the plan generated by the control system may conflict with each other. For example, the operations needed to be scheduled in the plan to achieve the goal of departing an outbound rail vehicle system at or before a scheduled time may conflict with the operations needed to be scheduled in the plan to ensure that all cargo containers that arrive in the terminal before the gate cutoff time are loaded onto that rail vehicle system. Therefore, it may be infeasible to meet all of the goals, all of the time. In some situations, the control system may need to create a plan that causes one goal to not be achieved (e.g., delay an outbound rail vehicle system for departure after the scheduled time) in order to ensure that one or more high priority cargo containers are loaded onto the rail vehicle system. A cargo container may have higher priority than another cargo container based on the amount that a shipper is paying to move the cargo container, or the time period before the cargo within the cargo container spoils or wastes.

In order to appropriately trade-off between goals in creating a plan, the control system can associate values (e.g., scores) with not meeting various goals. The values can be quantifiable measures (e.g., numbers) that are proportional to the extent by which the goals are not satisfied. For example, delaying departure of an outbound rail vehicle system by two hours may have a much higher value than delaying the departure by one hour, with the higher value indicating that the longer delay for the departure is less desirable. Not all goals may have equivalent scoring techniques. The magnitude of the values associated with the goals is chosen to reflect the varying importance of the goals. For example, having 90% of the rail vehicle systems arriving into the terminal on time may have a lower value than having 90% of the rail vehicle systems departing from the terminal on time, thereby indicating that the goal of having the rail vehicle systems depart from the terminal on time is of greater importance or priority than having the rail vehicle systems arrive into the terminal on time. The scale or rate at which the values change for the different goals may be adjusted to control the efficiency and efficacy of the control system in generating the plan for the terminal.

The control system may monitor the efficiency at which the operations within the terminal are progressing according to the plan by measuring various efficiency metrics. The efficiency metrics can include spatial and temporal efficiency metrics. One example of a spatial metric includes a total crane gantry distance. This distance represents the distance that a crane moves in order to move a cargo container from one location to another. The crane equipment in the terminal may include intermodal yard cranes that can both move relative to the routes (referred to as trolley movement) and move cranes along gantries of the equipment relative to the cargo containers, while the remainder of the crane equipment remains stationary (referred to as gantry movement). The total crane gantry distance can represent the total distance that a crane or several cranes move along the gantries to move a single cargo container or to move several cargo containers within a designated time period (e.g., per hour, per day, etc.).

Another spatial efficiency metric includes a total crane trolley distance. This distance represents the distance that a crane moves along one or more routes in order to move one or more cargo containers from one location to another. The total crane trolley distance can represent the total distance that a crane or several cranes move along the routes to move a single cargo container or to move several cargo containers within a designated time period (e.g., per hour, per day, etc.).

One example of a temporal efficiency metric includes a total crane idle time. This metric represents the time period that one or more, or all, cranes are not moving or otherwise operating to move cargo containers within the terminal. Another temporal efficiency metric includes a total driver waiting time. This metric represents the time period that one or more, or all, OTR vehicles are stationary and waiting for cargo containers to be moved onto the OTR vehicles or off of the OTR vehicles.

Another temporal efficiency metric includes an average or median driver turn time. This metric represents the average or median of how long it takes for the OTR vehicles to enter into the terminal via the truck in-gate, drop off and/or pick up cargo container(s) 204, and exit from the terminal via the truck-out gate. Another temporal efficiency metric includes a number of missed cargo containers. This metric represents how many cargo containers were not placed onto an outbound rail vehicle system in time before the rail vehicle system left the terminal.

The efficiency metrics that are tracked by the control system can have different units of measure. For example, the temporal efficiency metrics may have units of minutes, hours, days, etc., while the spatial efficiency metrics may have units of meters. In order to compare the metrics, the control system can associate values (e.g., scores) with the different metrics, similar to the values associated with the goals described above. Larger values can indicate less efficient efficiency metrics. For example, an average driver turn time of five hours and a total crane trolley distance of one hundred meters may have the same value (e.g., 50), while an average driver turn time of seven hours and a total crane trolley distance of one hundred twenty meters may have the same, larger value (e.g., 72). The values may vary along different scales for different metrics. For example, a ten percent increase in one efficiency metric may result in the value for that metric increasing by five percent, while a ten percent in another efficiency metric may result in the value for that metric increasing by twenty percent.

The control system generates or modifies a plan for the operations in the terminal subject to one or more constraints on the plan. A planning constraint includes a limitation or restriction that cannot be violated while generating the plan. For example, one constraint may be a prohibition against generating a plan that directs two different vehicles, cranes, or other terminal equipment to be in the exact same location at the exact same time.

Another example of a planning constraint includes CHE capacity limitations. The CHE 328 (shown in FIG. 3) in the terminal is limited by how many containers can be concurrently or simultaneously moved, how far the containers can be moved, how heavy of a container the various CHE can move, etc., due to mechanical or other physical limitations of the CHE. The planning constraints can include CHE travel times or speeds that represent lower or minimum limits on how long is needed for various CHE to move or how fast the various CHE can move. The CHE shown in FIG. 3 represents a crane. In other embodiments, the CHE can be other equipment.

The control system may determine the efficiency metrics and, subject to the planning constraints, formulate one or more plans for the terminal that achieves one or more goals. The control system can generate the plan to increase or decrease the efficiency metrics, as applicable, while achieving the goals and not violating the constraints. The control system represents hardware circuity that includes and/or is connected with one or more processors (e.g., microprocessors, field programmable gate arrays, or integrated circuits) that operate to perform the functions described herein. The processor(s) of the control system may include several processors that each perform one or more different functions than the other processor(s) or several processors that share performance of one or more of the same functions. The processor(s) are described herein as various modules, which can represent different processors performing different functions. One or more embodiments of the inventive subject matter described herein, however, may involve the functions performed by two or more modules being performed by the same processor. The modules can therefore represent different processors in one embodiment. Alternatively, the modules can represent functions performed by the processors, such as instructions or algorithms that direct operations of the processors.

The modules of the control system include a switching and railcar assignment module 302 (“Car Assignment” in FIG. 3), a container location assignment module 304 (“Container Assignment” in FIG. 3), and a work order generation module 306 (“WO Generation” in FIG. 3). These modules can operate in a hierarchical manner to create or to modify a plan.

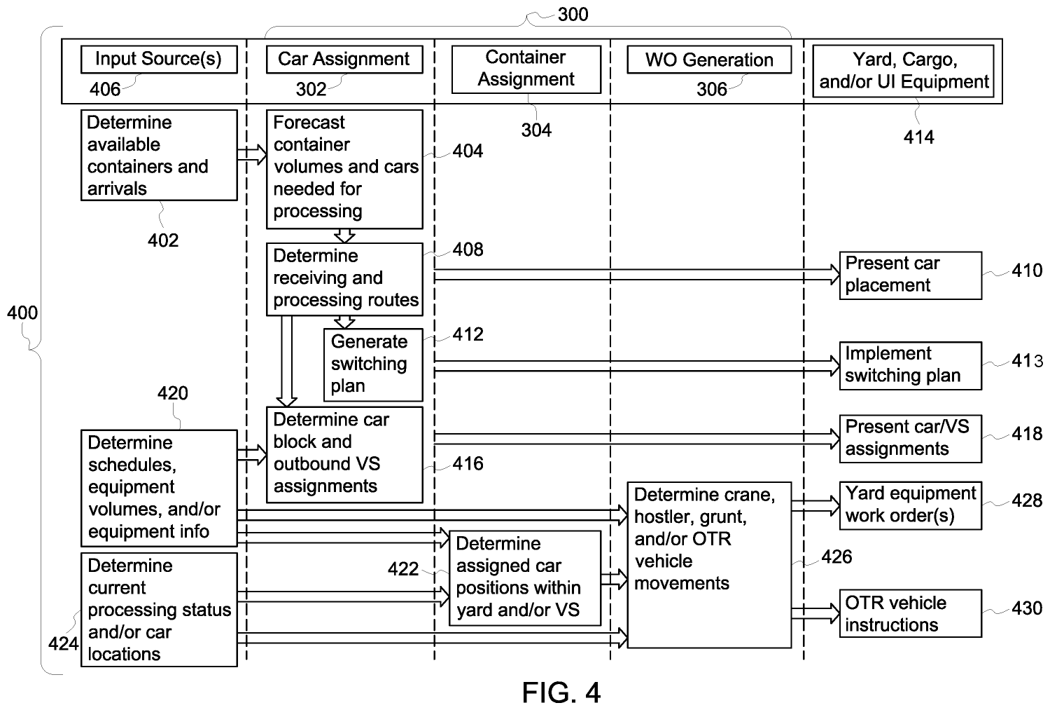

With continued reference to the control system shown in FIG. 3, FIG. 4 illustrates a swim lane diagram 400 of one embodiment of operation of the control system. The swim lane diagram shown in FIG. 4 can represent a flowchart or algorithm of operation of the control system, such as the operations of the processors to perform the functions described herein. The functions illustrated in the diagram are shown below the components of the control system and terminal that perform the corresponding functions in one embodiment. Alternatively, one or more of the functions may be partially or entirely performed by another component.

The swim lane diagram may represent or be used to generate instructions (e.g., software) for directing the operations of the processors. The car assignment module determines the containers to be processed by block, decides the processing routes for inbound vehicles, and assigns block codes to outbound vehicles before the vehicles are loaded with the containers. Using output from the car assignment module, the container assignment module determines locations of inbound and outbound containers to efficiently manage the terminal and/or to reduce or minimize stack gaps in the rail vehicle systems to reduce fuel consumption (e.g., relative to other locations of containers on a rail vehicle system).

A stack gap represents a change in height between adjacent vehicles in a rail vehicle system. For example, a stack gap may occur when a first vehicle and a third vehicle in the same vehicle system (e.g., the same train) each has two containers stacked on top of each other, while a second vehicle that is between the first and third vehicles may have only a single container or no containers. This stack gap can increase wind resistance (and, therefore, fuel consumption) relative to the first, second, and third vehicles having the same height or number of containers.

The WO generation module creates work orders that ensure the containers and CHE are moved in efficient and timely manners. The work orders can be the part of the plan that implements the plan in the terminal. For example, the work orders may initiate the CHE to move the cargo container to transfer the cargo containers from a first transportation vehicle (associated with a first transportation mode) to a second transportation vehicle (associated with a second transportation mode). In one embodiment, the work orders include electronic or electromagnetic signals that are communicated from the WO generation module to an output device 308 (e.g., a communication device, such as transceiving circuitry and antenna(s)), for communication to the CHE. Receipt of the signals can cause the CHE to automatically move or otherwise operate according to the plan. For example, the CHE may include transceiving circuitry and antennas that receive the signals and convey the signals to the motors or other equipment that move the CHE according to the plan. Optionally, the work orders may be communicated to display devices (e.g., equipment 414 shown in FIG. 4) accessible to the drivers, such as mobile phones, tablet computers, etc. The work orders may be displayed as instructions to the drivers,

With respect to the car assignment module, at step 402 (shown in FIG. 4), the car assignment module can obtain information on available containers within the terminal (e.g., containers that are ready to be shipped out of the terminal via one or more vehicles) and upcoming arrivals of containers. The car assignment module can receive this information from one or more input sources 406. For example, this information can be communicated to the control system (and the car assignment module) via an input device 310, such as transceiving equipment and one or more antenna, a keyboard, a microphone, or other device that receives information from another source. In one embodiment, at least some of this information is communicated from or accessed from one or more memory devices, such as a computer hard drive, optical disc, etc. These memory devices can represent a single memory device or several different memory devices.

A first memory device 312 (“Schedules” in FIG. 3) may store schedules of rail vehicle systems and/or containers entering into and/or leaving the terminal, as well as the times and/or dates at which the rail vehicle systems and/or containers are scheduled to enter into and/or leave the terminal. A second memory device 314 (“Priorities” in FIG. 3) may store quantified priorities of the container or the cargo carried within the containers. Containers or cargo having larger values of priorities may be scheduled within the plan for movement within, into, and/or out of the terminal before containers or cargo having lower values of priority.

A third memory device 316 (“Yard Database” in FIG. 3) may store information representative of where different routes, CHE, gates, etc., are located within the terminal. A fourth memory device 318 (“Cargo Database” in FIG. 3) may store information representative of where the containers are located within the terminal. The information stored in the memory devices may be manually input into the memory devices, may be automatically recorded into the memory devices (e.g., by receiving the information from another system, such as a dispatch or scheduling system, by receiving location information from global positioning system receivers, etc.).

At step 404, the car assignment module determines container volumes and vehicles that are needed for processing containers in the terminal. The car assignment module can determine the container volumes and needed vehicles based on the information obtained by the car assignment module at step 402. The car assignment module can forecast the container volumes and/or the needed vehicles by estimating how many containers are scheduled to arrive at the terminal within an upcoming period of time (e.g., the next day) and/or how many containers are scheduled to depart from the terminal within the upcoming period of time. These estimates can be based on at least some of the information obtained from the input sources. Suitable input sources may include schedules obtained from the memory device, the rail vehicle system(s) on which the containers are scheduled to be transported, blocks of two or more containers that are to travel together in a rail vehicle system into or out of the terminal, etc. The information obtained by the car assignment module at step 402 may be updated as actual information regarding the influx and/or output of containers into and/or out of the terminal changes.

At step 408, the car assignment module determines routes in the storage routes and/or processing routes on which rail vehicle systems are to travel. The car assignment module can select the routes by determining where various inbound and/or outbound vehicles are to be located for loading and/or unloading cargo containers. For example, the car assignment module may select routes in the storage routes on which rail vehicle systems are to be received into the terminal and may select routes in the processing routes on which containers are to be loaded onto and/or unloaded from rail vehicle systems. The car assignment module may select these routes based on the container volumes and/or needed vehicles that are forecast by the car assignment module at step 404.

At step 410, the car assignment module optionally presents the selected routes on which the rail vehicle systems are to be received and/or on which containers are to be loaded and/or unloaded. This information can be presented on one or more output devices 414 (“Yard, Cargo, and/or UI Equipment” in FIG. 4). The item 414 in FIG. 4 represents an output device or one or more of the CHE.

The car assignment module may generate and communicate one or more electronic signals to the output device. This may additional or alternatively may represent an electronic display device (e.g., touchscreen, monitor, etc.), speaker, or other device capable of presenting information to a user, to cause the output device to communicate the selected routes. The car assignment module optionally may receive changes to these selected routes from the input device. This can allow for a user to change the selected routes, such as in performing “what if” planning scenarios by adjusting various forecasted equipment volumes, available vehicles, rates at which the CHE lifts the containers, constraints on whether switches between routes can be operated, and inbound estimated times of arrival for vehicle systems.

At step 412, the car assignment module determines a switching plan based on the selected routes and/or selected locations for the containers determined at step 408. The switching plan includes a schedule for which switches are to be actuated, which direction the switches are to be actuated, and/or when the switches are to be actuated to control which routes the rail vehicles travel on during travel on the routes within the terminal.

At step 413, the car assignment module optionally implements the switching plan to at least some of the CHE. In one embodiment, the car assignment module creates and communicates an electric or electromagnetic signal to switches that include transceiving circuitry and/or antennas to automatically actuate the switches according to the switching plan. For example, in one embodiment, responsive to receiving the switching plan the switches may autonomously (e.g., without operator intervention) change states at the times dictated by the switching plan. Alternatively, the switching plan may be communicated to the output device or other CHE to be presented to a user for manual control of the switches according to the switching plan.

At step 416, the car assignment module determines car block assignments and outbound vehicle system assignments. The car block assignments are designations of which containers are to travel together as a group out of the terminal in a rail vehicle system to the same destination. The outbound vehicle system assignments are designations of which containers or blocks of containers are to be included in the various vehicle systems scheduled for departure from the terminal. The car block assignments and outbound vehicle system assignments that are output by the car assignment module may form at least one part of the plan for the terminal.

These assignments can be based on a variety of information obtained by the car assignment module at step 420. The information that is obtained can include the routes and/or container positions selected at step 408, the schedules of the vehicle systems, release time targets of the containers, the volume of actual CHE in the terminal, the expected or scheduled availability of the CHE in the terminal at different times, the sizes of CHEs in the terminal, the types of CHE in the terminal, the commodities of the CHE in the terminal, the locations of CHE relative to the routes and/or where containers or vehicles are assigned to be located, and/or billing destinations, which can be obtained from one or more of the input sources, as shown in FIG. 4.

These assignments can be based on the routes and/or container positions selected at 408. For example, those containers that are scheduled for travel to the same location may be placed next to each other on the same route, and the route on which these containers are placed may be selected based on when the remainder of the vehicle system is to be constructed for departure from the terminal.

The car block and/or vehicle system assignments may be based on the schedules of the vehicle systems, such as when the various vehicle systems are scheduled to arrive and/or depart from the terminal. The assignments may be based on release time targets of the containers, which may be a goal of the terminal (e.g., upper time limits on how long a container is to be in the terminal). For example, the module may assign several containers to the same vehicle system that is scheduled to depart before the scheduled departure time of the containers.

Optionally, the assignments may be based on the volume of actual CHE in the terminal and/or the expected or scheduled availability of the CHE in the terminal at different times. The assignments may be based on the sizes, types, and commodities of the CHE in the terminal, as well as the locations of CHE relative to the routes and/or where containers or vehicles are assigned to be located. The module can assign several containers that are to be moved on or off of the ground and/or vehicles to be located closer to the CHE that are known or expected to be in the terminal relative to other containers. As another example, some cranes may be equipped to move certain types of containers that other cranes cannot move. The vehicles holding these types of containers can be assigned to locations near the cranes that can lift the containers. The assignments may be based on billing destinations, such as where the containers are to be shipped to. For example, the containers destined to the same location may be assigned to the same route in the terminal.

At step 418, the car assignment module optionally presents the container and/or vehicle system assignments determined at step 416. This information can be presented on one or more of the output devices 414. In one embodiment, this information is displayed on a user interface of a display device that shows the vehicles on the routes in the terminal, along with the status of each vehicle, such as inbound to the terminal, outbound from the terminal, planned for placement on the ground, etc. The block assignments of the containers may be displayed. A user can select one or more vehicles and/or routes and changing the assignments as desired using the input device. The car assignment module may then modify the assignments based on the user modified assignments.

At step 422, the container assignment module determines assigned car positions within the terminal and/or within the vehicle systems in order to ensure that containers are planned to locations within the terminal to efficiently move the containers through the terminal. The assigned car positions indicate where a vehicle holding a particular container is located within the terminal and/or within a vehicle system. The containers and other cargo-carrying equipment can arrive in the terminal via rail vehicle systems or OTR vehicles, and can be classified as inbound or outbound depending on whether the containers are scheduled for arrival into the terminal or for departure from the terminal.

At step 424, the container assignment module obtains terminal process information from one or more of the input sources. This process information can include current statuses or states of the CHE, the containers, the vehicles, and/or the OTR vehicles. The information can be obtained from a variety of input sources, such as a CHE monitoring system 320, a gate monitoring system 322, and/or a yard input/output (I/O) system 324 (shown in FIG. 3). The systems may track the current locations, states, and/or operations of the CHE, OTR vehicles, and/or vehicle systems. Each of the systems may represent hardware circuitry that includes and/or is connected with one or more processors (e.g., microprocessors, field programmable gate arrays, or integrated circuits) that operate to perform the functions described herein. The CHE monitoring system communicates with CHE input devices 326, which report the status and/or location of various CHE. For example, the CHE input devices can include global positioning receivers, keyboards, or other devices that can receive information on current states or locations of the CHE and communicate signals to the CE monitoring system. The CHE monitoring system may include transceiving circuitry to permit the CHE monitoring system to communicate these signals with the container assignment module via one or more wired and/or wireless connections.

The gate monitoring system communicates with one or more gate input devices 330, which record entry and/or exit of the vehicles through the gates. For example, the input devices can include switches that are actuated when a gate opens or closes, keyboards, or other devices that can receive information on when a vehicle enters or exits the terminal. The input devices can generate and communicate signals representative of entry or exit of the vehicles to the gate monitoring system. The gate monitoring system may include transceiving circuitry to permit the gate monitoring system to communicate these signals with the container assignment module via one or more wired and/or wireless connections.

The yard input/output (I/O) system communicates with one or more route input devices 332, which track locations of the vehicles and/or vehicle systems on the routes in the terminal. For example, the input devices can include roadside transponders, cameras, keyboards, or other devices that receive information indicative of locations of objects on the routes. The input devices can generate and communicate signals representative of locations of the vehicles and/or vehicle systems to the yard input/output (I/O) system. The yard input/output (I/O) system may include transceiving circuitry to permit the yard input/output (I/O) system to communicate these signals with the container assignment module via one or more wired and/or wireless connections.

The systems can be included in the input sources, and the information obtained by the systems can be communicated to the container assignment module at step 424. This information is used by the container assignment module to determine the current state of the containers, CHE, vehicles, vehicle systems, etc., in the process of moving containers through the terminal. The container assignment module can obtain additional information determined at step 420 from the input sources, such as the routes and/or container positions selected at step 408, the schedules of the vehicle systems, release time targets of the containers, the volume of actual CHE in the terminal, the expected or scheduled availability of the CHE in the terminal at different times, the sizes of CHEs in the terminal, the types of CHE in the terminal, the commodities of the CHE in the terminal, the locations of CHE relative to the routes and/or where containers or vehicles are assigned to be located, and/or billing destinations.

Based on some or all of this information, the container assignment module determines where various vehicles are to be located on the routes and/or in a vehicle system. For example, the container assignment module may assign vehicles or blocks of vehicles to locations on a selected route being used to form a train for departing from the terminal when the vehicles can traverse the routes and switches to the selected route and the train is being built on the selected route. As another example, the container assignment module can determine where various vehicles or blocks of vehicles are to be located within a vehicle system based on whether the CHE can move the containers to the vehicles in the locations in the vehicle system.

The container assignment module can determine where the containers and vehicles are located in the vehicle systems to avoid stack gaps, as described above. For example, the container assignment module can assign the car positions in vehicle systems to avoid placing a vehicle with a shorter stack of containers between vehicles having taller stacks of containers in the vehicle system. The module can assign the car positions within the terminal to reduce the distance between the containers being loaded onto or off of the vehicles and/or to reduce the time needed to load and/or unload the containers.

The positions of the vehicles within the vehicle systems and/or within the terminal (e.g., car positions) that are assigned by the container assignment module can be included in the plan that is generated by the control system. The assigned car positions can be communicated from the container assignment module to the work order generation module, as shown in FIG. 4.

At step 426, the work order generation module determines movements of equipment within the terminal. The WO generation module can create, submit, and manage (e.g., track and set status) work orders to ensure the containers and other cargo-carrying equipment are moved in an efficient and timely manner. The WO generation module examines different sequences of moving containers or trailers of the OTR vehicles to get the containers between the assigned car positions in the terminal (e.g., on the ground, on storage routes, in the equipment yard, etc.) and the assigned car positions on the vehicle systems, as received from the container assignment module.

With respect to the CHE, the WO generation module can examine different movements of the cranes and containers based on nominal and upper limits on the range of movements of the crane, the time needed for each movement, and/or alternate ways to move the container (e.g., using a hostler). As one example, although it may be possible to move a container from an inbound OTR vehicle directly to a vehicle in a vehicle system, the WO generation module may instead direct the container to be moved to a wheeled position (e.g., on a trailer in the equipment yard that is not connected with an OTR vehicle) due to other constraints, such as an outbound vehicle system scheduled to leave before the container can get to and be loaded on the vehicle system.

Hostler moves in the terminal transport containers and trailers from one wheeled position to another. Depending upon the type of terminal and whether the containers are scheduled inbound to the terminal or outbound from the terminal, however, the WO generation module may direct the hostlers (included in CHE) to synchronously move or asynchronously move with movements of cranes. Synchronous movements include the hostler moving a container at the same time that the crane is moving to grab and lift the container, while asynchronous movements include the hostler moving the container while the crane remains stationary, and the crane moving only after the hostler has moved the container to a desired or designated location.

For example, for terminals having side-loader or top-pick cranes, the hostler may conduct synchronous moves with the crane. For terminals having overhead cranes, the hostler moves can be executed asynchronously and thereby allow more opportunity for fuel and efficiency savings. The WO generation module can determine the types, locations, and/or states of the OTR vehicles, cranes and hostlers, and determine movements for the OTR vehicles, cranes, and hostlers to achieve movement of the containers through the terminal.

As described above in connection with FIG. 2, some vehicles can carry two or more containers stacked on each other with IBCs securing the containers together. The WO generation module can examine the status of the cranes (e.g., whether stacking of containers is complete, from step 424) the locations of vehicles on which two or more containers are stacked (e.g., from step 422), and/or schedules for departure of the vehicle system that includes the stacked containers (e.g., from step 420) to determine whether IBCs between the containers are unlocked, whether the IBCs are to be removed (e.g., prior to removing a container from the stack), whether the IBCs are be added or inserted between the containers (e.g., after the crane has finished stacking the containers), or whether the IBCs are to be locked to secure the containers together (e.g., after the crane has finished stacking the containers and moved to a safe position for the IBCs to be locked). The WO generation module can examine the current locations and statuses of the containers, cranes, other CHE, and/or OTR vehicles in order to determine which OTR vehicles can move the containers, where the OTR vehicles should park in the equipment yard while waiting for pickup or drop off of a container, etc., in order to move the containers through the terminal 104 more efficiently.

The WO generation module can examine different possible combinations or permutations of sequences of movements of the CHE, containers, vehicles, vehicles, etc., in order to determine which combination of movements results in improved efficiency metrics relative to other combinations of movements. The selected combination of movements may be included in the plan for the terminal. The plan may be used to generate work orders for the CHE (e.g., at step 428) and/or work orders for the drivers of the OTR vehicles (e.g., at step 430). The work orders for the CHE may be communicated as electronic signals generated by the WO generation module to the CHE (e.g., the equipment 414). These signals may be displayed on display screens of the CHE to direct operators of the CHE how to operate the equipment and/or may be communicated to the equipment to automatically control the equipment. For example, responsive to receiving the signals, motors or other components of the CHE may begin operating per the plan as directed by the received signals. The work orders for the OTR vehicle drivers may be communicated to display devices (e.g., equipment 414) accessible to the drivers, such as mobile phones, tablet computers, etc. The work orders may be displayed as instructions to the drivers, such as to drive the OTR vehicle to a designated parking spot in the equipment yard by a designated time, then to drive the OTR vehicle to a designated location in the equipment yard by a later designated time to detach from a trailer having a container, then to drive the OTR vehicle to another designated location in the equipment yard by a later designated time to attach another trailer having another container, and then to exit the terminal by another designated time.

The work orders or other instructions generated by the WO generation module (e.g., at step 428 and/or step 430), the car block assignments and/or outbound vehicle system assignments generated by the car assignment module (e.g., at step 416), and/or the assigned car positions in the terminal and/or vehicle systems generated by the container assignment module (e.g., at step 422) can form the plan for the terminal. The plan may be updated or modified as circumstances change, such as when a vehicle system arrives or departs at a time other than a schedule time, when an OTR vehicle arrives or departs at a time other than a schedule time, when CHE breaks down or needs repair or maintenance, or the like. As described herein, the plan may be used to instruct manual operators of the equipment and/or vehicles to efficiently operate the equipment and/or vehicles to move the containers through the terminal, and/or may be used to automatically control operations of the equipment and/or vehicles to efficiently operate the equipment and/or vehicles to move the containers through the terminal.

In one embodiment, an intermodal terminal control system includes one or more processors configured to determine characteristics of cargo containers scheduled for one or more of receipt into or travel out of an intermodal terminal connected with both rail routes and automobile routes, determine characteristics of cargo handling equipment within the intermodal terminal, determine characteristics of rail vehicles scheduled for one or more of entry into or travel out of the intermodal terminal, and determine characteristics of automobile vehicles scheduled for entry into or travel out of the intermodal terminal. The one or more processors may determine one or more constraints on cargo handling operations involving transferring the cargo containers between different modes of transportation in the intermodal terminal. The one or more processors are further configured to determine a plan for the cargo handling equipment to transfer the cargo containers between the different modes of transportation within the intermodal terminal. The plan designates a sequence of operations to be performed in moving the cargo containers with the cargo handling equipment. The plan may be determined based at least in part on the characteristics of the cargo containers, the characteristics of the cargo handling equipment, the characteristics of the rail vehicles, and the characteristics of the vehicles.

Optionally, the one or more processors may determine the plan to meet a goal of at least a non-zero designated threshold of the rail vehicles arriving into the intermodal terminal on schedule. Optionally, the one or more processors may determine the plan to meet a goal of at least a non-zero designated threshold of the rail vehicles departing from the intermodal terminal on schedule. Optionally, the one or more processors may determine the plan to meet a goal of at least a non-zero designated threshold of the cargo containers arriving in the intermodal terminal on one or more of the rail vehicles being available for pickup by one or more of the automobile vehicles on schedule. Optionally, the one or more processors may determine the plan to meet a goal of at least a non-zero designated threshold of the cargo containers arriving in the intermodal terminal on one or more of the automobile vehicles prior to a designated time being onboard one or more of the rail vehicles prior to a scheduled departure time of the one or more rail vehicles. Optionally, the one or more processors may determine the plan to meet a goal of a driver turn time of one or more of the automobile vehicles being less than a designated threshold.

Optionally, the one or more processors may determine the plan to meet two or more, but not all, of a first goal of at least a non-zero designated threshold of the rail vehicles arriving into the intermodal terminal on schedule, a second goal of at least a non-zero designated threshold of the rail vehicles departing from the intermodal terminal on schedule, a third goal of at least a non-zero designated threshold of the cargo containers arriving in the intermodal terminal on one or more of the rail vehicles being available for pickup by one or more of the automobile vehicles on schedule, a fourth goal of at least a non-zero designated threshold of the cargo containers arriving in the intermodal terminal on one or more of the automobile vehicles prior to a designated time being onboard one or more of the rail vehicles prior to a scheduled departure time of the one or more rail vehicles, and/or a fifth goal of a driver turn time of one or more of the automobile vehicles being less than a designated threshold.

Optionally, the one or more processors may determine the plan in order to increase an efficiency metric of a total crane gantry distance of the cargo handling equipment relative to another, different plan for the intermodal terminal. Optionally, the one or more processors may determine the plan in order to increase an efficiency metric of a total crane trolley distance of the cargo handling equipment relative to another, different plan for the intermodal terminal. Optionally, the one or more processors may determine the plan in order to increase an efficiency metric of a total number of lifts of the cargo containers by the cargo handling equipment relative to another, different plan for the intermodal terminal. Optionally, the one or more processors may determine the plan in order to increase an efficiency metric of a total idle time of cranes of the cargo handling equipment relative to another, different plan for the intermodal terminal. Optionally, the one or more processors may determine the plan in order to increase an efficiency metric of a total driver waiting time of the automobile vehicles relative to another, different plan for the intermodal terminal.

Optionally, the one or more processors may determine the plan in order to increase an efficiency metric of a number of the cargo containers that missed outbound departures of the rail vehicles relative to another, different plan for the intermodal terminal. Optionally, the one or more processors may determine the plan in order to increase efficiency metrics of a total crane gantry distance of the cargo handling equipment, a total crane trolley distance of the cargo handling equipment, a total number of lifts of the cargo containers by the cargo handling equipment, a total idle time of cranes of the cargo handling equipment, a total driver waiting time of the automobile vehicles, and a number of the cargo containers that missed outbound departures of the rail vehicles relative to another, different plan for the intermodal terminal. Optionally, the one or more processors may determine the plan while avoiding physical conflict between the cargo handling equipment. Optionally, the one or more processors may determine the plan while avoiding exceeding a capacity of the cargo handling equipment. Optionally, the one or more processors may determine the plan while avoiding violating a lower limit on travel time of the cargo handling equipment. Optionally, the one or more processors may determine the plan while avoiding physical conflict between the cargo handling equipment, avoiding exceeding a capacity of the cargo handling equipment, and avoiding violating a lower limit on travel time of the cargo handling equipment.

Optionally, the one or more processors may determine available cargo containers in an equipment yard of the intermodal terminal, determine arrivals of the automobile vehicles into the intermodal terminal, and determine arrivals of the rail vehicles into the intermodal yard, and the one or more processors may determine the plan based on the available cargo containers, the arrivals of the automobile vehicles, and the arrivals of the rail vehicles. Optionally, the plan includes location assignments of the cargo containers in one or more of routes or rail vehicles in the intermodal terminal. Optionally, the one or more processors may determine the plan to avoid a stack gap in a rail vehicle system. Optionally, the one or more processors may determine the plan based on a range of one or more cranes of the cargo handling equipment and a time period required for the one or more cranes to move the cargo containers. Optionally, the one or more processors may communicate a control signal to one or more of the cargo handling equipment to direct the cargo handling equipment to automatically move one or more of the cargo containers according to the plan. In one embodiment, a method includes determining characteristics of cargo containers scheduled for one or more of receipt into or travel out of an intermodal terminal connected with both rail routes and automobile routes, determining characteristics of cargo handling equipment within the intermodal terminal, determining characteristics of rail vehicles scheduled for one or more of entry into or travel out of the intermodal terminal, determining characteristics of automobile vehicles scheduled for entry into or travel out of the intermodal terminal, determining one or more constraints on cargo handling operations involving transferring the cargo containers between different modes of transportation in the intermodal terminal, and determining a plan for the cargo handling equipment to transfer the cargo containers between the different modes of transportation within the intermodal terminal. The plan designates a sequence of operations to be performed in moving the cargo containers with the cargo handling equipment. The plan is determined based on the characteristics of the cargo containers, the characteristics of the cargo handling equipment, the characteristics of the rail vehicles, and the characteristics of the automobile vehicles.

Optionally, the plan is determined to meet one or more of a first goal of at least a non-zero designated threshold of the rail vehicles arriving into the intermodal terminal on schedule, a second goal of at least a non-zero designated threshold of the rail vehicles departing from the intermodal terminal on schedule, a third goal of at least a non-zero designated threshold of the cargo containers arriving in the intermodal terminal on one or more of the rail vehicles being available for pickup by one or more of the automobile vehicles on schedule, a fourth goal of at least a non-zero designated threshold of the cargo containers arriving in the intermodal terminal on one or more of the automobile vehicles prior to a designated time being onboard one or more of the rail vehicles prior to a scheduled departure time of the one or more rail vehicles, or a fifth goal of a driver turn time of one or more of the automobile vehicles being less than a designated threshold.

Optionally, the plan is determined in order to increase efficiency metrics of a total crane gantry distance of the cargo handling equipment, a total crane trolley distance of the cargo handling equipment, a total number of lifts of the cargo containers by the cargo handling equipment, a total idle time of cranes of the cargo handling equipment, a total driver waiting time of the automobile vehicles, and a number of the cargo containers that missed outbound departures of the rail vehicles relative to another, different plan for the intermodal terminal. Optionally, the method may include communicating a control signal to one or more of the cargo handling equipment to direct the cargo handling equipment to automatically move one or more of the cargo containers according to the plan. In one or more embodiments, system is provided that includes one or more processors that may determine at least one characteristic of at least one cargo container that is scheduled for one or more of receipt into or travel out of a terminal. The terminal is connected with different routes configured to accommodate a plurality of differing transportation vehicles. The one or more processors may determine at least one characteristic of cargo handling equipment associated with the terminal. The cargo handling equipment is selected from cranes, lifts, conveyors, and elevators. The one or more processors may determine at least one characteristic of a first transportation vehicle of the plurality of differing transportation vehicles that is scheduled for one or more of entry into or travel out of the terminal. The first transportation vehicle is associated with a first mode of transportation. The one or more processors may determine at least one characteristic of a different, second transportation vehicle of the plurality of differing transportation vehicles that is scheduled for entry into or travel out of the terminal. The second transportation vehicle is associated with a different, second mode of transportation. The one or more processors may determine at least one constraint associated with cargo handling operations involving transferring the at least one cargo container from the first mode of transportation to the second mode of transportation via the cargo handling equipment. The one or more processors may determine a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations. The one or more processors are further configured to initiate the cargo handling equipment to move the at least one cargo container to transfer the at least one cargo container from the first transportation vehicle to the second transportation vehicle according to the plan.

Optionally, the constraint comprises at least one of avoiding physical conflict between the cargo handling equipment and avoiding exceeding a capacity of the cargo handling equipment. Optionally, the one or more processors are further configured to determine the plan to meet a goal of at least a non-zero designated threshold of transportation vehicles of the first mode of transportation departing from the terminal on schedule. Optionally, the one or more processors are further configured to determine the plan to meet a goal of at least a non-zero designated threshold of the at least one cargo container arriving in the terminal on the first transportation vehicle being available for pickup by the second transportation vehicle on schedule. Optionally, the one or more processors are further configured to determine the plan to meet a goal of at least a non-zero designated threshold of the at least one cargo container, arriving in the terminal on the first transportation vehicle, being onboard the second transportation vehicle prior to a scheduled departure time of the second transportation vehicle.

Optionally, the one or more processors are further configured to determine the plan to meet a goal of a driver turn time of the second transportation vehicle being less than a designated threshold. Optionally, the one or more processors may determine the plan to meet two or more of: (i) a first goal of at least a non-zero designated threshold of transportation vehicles of the first mode of transportation arriving into the terminal on schedule; (ii) a second goal of at least a non-zero designated threshold of transportation vehicles of the first mode of transportation departing from the terminal on schedule; (iii) a third goal of the at least one cargo container arriving in the terminal on the first transportation vehicle and being available for pickup by the second transportation vehicle; and/or (iv) a fourth goal of a driver turn time of the second transportation vehicle being less than a designated threshold. Optionally, the one or more processors may associate a respective value with each of the goals that the plan is determined to meet based on an extent by which the associated goal is not satisfied.

In one or more embodiments, a system is provided that includes one or more processors configured to determine at least one characteristic of at least one cargo container that is scheduled for one or more of receipt into or travel out of a terminal. The terminal is connected with different routes configured to accommodate a plurality of differing transportation vehicles. The one or more processors may determine at least one characteristic of cargo handling equipment associated with the terminal. The cargo handling equipment is selected from cranes, lifts, conveyors, and elevators. The one or more processors may determine at least one characteristic of a first transportation vehicle of the plurality of differing transportation vehicles that is scheduled entry into the terminal. The first transportation vehicle is associated with a first mode of transportation. The one or more processors may determine at least one characteristic of a different, second transportation vehicle of the plurality of differing transportation vehicles that is scheduled for travel out of the terminal. The second transportation vehicle is associated with a different, second mode of transportation. The one or more processors may determine at least one constraint associated with cargo handling operations involving transferring the at least one cargo container from the first mode of transportation to the second mode of transportation. The one or more processors may determine a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the different, second transportation vehicle, and the constraint associated with the cargo handling operations. The one or more processors are further configured to initiate the cargo handling equipment to move the at least one cargo container to transfer the at least one cargo container from the first transportation vehicle to the second transportation vehicle according to the plan. The one or more processors may determine the plan in order to increase, relative to another, different plan for the terminal, one or more of: an efficiency metric of a total crane gantry distance of the cargo handling equipment, an efficiency metric of a total crane trolley distance of the cargo handling equipment, an efficiency metric of a total number of lifts of the at least one cargo container by the cargo handling equipment, an efficiency metric of a total idle time of the cargo handling equipment, an efficiency metric of a total driver waiting time of transportation vehicles associated with the second mode of transportation, and/or an efficiency metric of a number of the at least one cargo container that missed outbound departures of transportation vehicles associated with the first mode of transportation.

Optionally, the one or more processors may determine the plan to avoid violating a lower limit on travel time of the cargo handling equipment. Optionally, the at least one characteristic of the at least one cargo container includes quantified priority values of plural cargo containers. The one or more processors may determine the plan for the cargo handling equipment to move one or more of the cargo containers with a higher priority value prior to moving one or more of the cargo containers with a lower priority value. Optionally, the plan includes location assignments of the at least one cargo container in the different routes. Optionally, the plan assigns a location to which to move a first cargo container of the at least one cargo container, a time at which the first cargo container is to be moved, and a first cargo handling equipment assigned to move the first cargo container at the time that is assigned. Optionally, the plan includes a switching plan to control which routes of the terminal are traveled on by rail vehicles. The switching plan includes a schedule that identifies switches to be actuated, directions in which to actuate the switches, and times at which to actuate the switches. Optionally, the one or more processors may determine the plan to avoid a stack gap in a rail vehicle system that represents the second transportation vehicle. Optionally, the one or more processors may determine the plan based on a range of one or more cranes of the cargo handling equipment and a time period required for the one or more cranes to move the at least one cargo container. Optionally, the one or more processors may monitor each efficiency metric over time and assign a respective value for each of the efficiency metrics based on a tracked efficiency of the efficiency metric. Optionally, the one or more processors may modify the plan or generate a different plan based on the values assigned to the efficiency metrics.

Optionally, the one or more processors may determine the plan to assign the first transportation vehicle to a first processing route of the routes for the cargo handling equipment to unload the at least one cargo container from the first transportation vehicle, and to assign the second transportation vehicle to a second processing route of the routes for the cargo handling equipment to load the at least one cargo container onto the second transportation vehicle. In one or more embodiments, a method is provided that includes determining at least one characteristic of at least one cargo container that is scheduled for one or more of receipt into or travel out of a terminal. The terminal is connected with different routes configured to accommodate a plurality of differing transportation vehicles. The method includes determining at least one characteristic of cargo handling equipment associated with the terminal. The cargo handling equipment is selected from cranes, lifts, conveyors, and elevators. The method includes determining at least one characteristic of a first transportation vehicle of the plurality of differing transportation vehicles that is scheduled for one or more of entry into or travel out of the terminal. The first transportation vehicle is associated with a first mode of transportation. The method includes determining at least one characteristic of a different, second transportation vehicle of the plurality of differing transportation vehicles that is scheduled for entry into or travel out of the terminal. The second transportation vehicle is associated with a different, second mode of transportation. The method includes determining at least one constraint associated with cargo handling operations involving transferring the at least one cargo container from the first mode of transportation to the second mode of transportation via the cargo handling equipment. The method includes determining a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations. The method further includes initiating the cargo handling equipment to move the at least one cargo container to transfer the at least one cargo container from the first transportation vehicle to the second transportation vehicle according to the plan. Optionally, the cargo handling equipment is initiated to move the at least one cargo container by generating a control signal to one or more of (i) remotely control the cargo handling equipment to move the at least one cargo container, or (ii) display instructions on a display device for viewing by an operator of the cargo handling equipment.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that may incorporate the recited features. Moreover, unless explicitly stated to the contrary, embodiments “comprising,” “including,” or “having” an element or a plurality of elements having a particular property may include additional such elements not having that property.

The above description is illustrative and not restrictive. For example, the above-described embodiments (and/or examples thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the inventive subject matter and may to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A system comprising one or more processors that are configured to determine:
at least one characteristic of at least one cargo container that is scheduled for one or more of receipt into or travel out of a terminal, and the terminal is connected with different routes configured to accommodate a plurality of differing transportation vehicles,
at least one characteristic of cargo handling equipment associated with the terminal, the cargo handling equipment being selected from cranes, lifts, conveyors, and elevators,
at least one characteristic of a first transportation vehicle of the plurality of differing transportation vehicles that is scheduled for one or more of entry into or travel out of the terminal, and the first transportation vehicle being associated with a first mode of transportation,
at least one characteristic of a different, second transportation vehicle of the plurality of differing transportation vehicles that is scheduled for entry into or travel out of the terminal, and the second transportation vehicle being associated with a different, second mode of transportation,
at least one constraint associated with cargo handling operations involving transferring the at least one cargo container from the first mode of transportation to the second mode of transportation via the cargo handling equipment, and
a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations; and
the one or more processors are further configured to initiate the cargo handling equipment to move the at least one cargo container to transfer the at least one cargo container from the first transportation vehicle to the second transportation vehicle according to the plan.

2. The system of claim 1, wherein the constraint comprises at least one of avoiding physical conflict between the cargo handling equipment and avoiding exceeding a capacity of the cargo handling equipment.

3. The system of claim 1, wherein the one or more processors are further configured to determine the plan to meet a goal of at least a non-zero designated threshold of transportation vehicles of the first mode of transportation departing from the terminal on schedule.

4. The system of claim 1, wherein the one or more processors are further configured to determine the plan to meet a goal of at least a non-zero designated threshold of the at least one cargo container arriving in the terminal on the first transportation vehicle being available for pickup by the second transportation vehicle on schedule.

5. The system of claim 1, wherein the one or more processors are further configured to determine the plan to meet a goal of at least a non-zero designated threshold of the at least one cargo container, arriving in the terminal on the first transportation vehicle, being onboard the second transportation vehicle prior to a scheduled departure time of the second transportation vehicle.

6. The system of claim 1, wherein the one or more processors are further configured to determine the plan to meet a goal of a driver turn time of the second transportation vehicle being less than a designated threshold.

7. The system of claim 1, wherein the one or more processors are configured to determine the plan to meet two or more of:
a first goal of at least a non-zero designated threshold of transportation vehicles of the first mode of transportation arriving into the terminal on schedule,
a second goal of at least a non-zero designated threshold of transportation vehicles of the first mode of transportation departing from the terminal on schedule,
a third goal of the at least one cargo container arriving in the terminal on the first transportation vehicle and being available for pickup by the second transportation vehicle,
a fourth goal of a driver turn time of the second transportation vehicle being less than a designated threshold.

8. The system of claim 7, wherein the one or more processors are configured to associate a respective value with each of the goals that the plan is determined to meet based on an extent by which the associated goal is not satisfied.

9. A system comprising one or more processors that are configured to determine:
at least one characteristic of at least one cargo container that is scheduled for one or more of receipt into or travel out of a terminal, and the terminal is connected with different routes configured to accommodate a plurality of differing transportation vehicles,
at least one characteristic of cargo handling equipment associated with the terminal, the cargo handling equipment being selected from cranes, lifts, conveyors, and elevators,
at least one characteristic of a first transportation vehicle of the plurality of differing transportation vehicles that is scheduled entry into the terminal, and the first transportation vehicle being associated with a first mode of transportation,
at least one characteristic of a different, second transportation vehicle of the plurality of differing transportation vehicles that is scheduled for travel out of the terminal, and the second transportation vehicle being associated with a different, second mode of transportation,
at least one constraint associated with cargo handling operations involving transferring the at least one cargo container from the first mode of transportation to the second mode of transportation, and
a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations; and
the one or more processors are further configured to initiate the cargo handling equipment to move the at least one cargo container to transfer the at least one cargo container from the first transportation vehicle to the second transportation vehicle according to the plan,
wherein the one or more processors are configured to determine the plan in order to increase, relative to another, different plan for the terminal, one or more of:
an efficiency metric of a total crane gantry distance of the cargo handling equipment,
an efficiency metric of a total crane trolley distance of the cargo handling equipment,
an efficiency metric of a total number of lifts of the at least one cargo container by the cargo handling equipment,
an efficiency metric of a total idle time of the cargo handling equipment,
an efficiency metric of a total driver waiting time of transportation vehicles associated with the second mode of transportation,
an efficiency metric of a number of the at least one cargo container that missed outbound departures of transportation vehicles associated with the first mode of transportation.

10. The system of claim 9, wherein the one or more processors are further configured to determine the plan to avoid violating a lower limit on travel time of the cargo handling equipment.

11. The system of claim 9, wherein the at least one characteristic of the at least one cargo container includes quantified priority values of plural cargo containers, and the one or more processors are configured to determine the plan for the cargo handling equipment to move one or more of the cargo containers with a higher priority value prior to moving one or more of the cargo containers with a lower priority value.

12. The system of claim 9, wherein the plan includes location assignments of the at least one cargo container in the different routes.

13. The system of claim 9, wherein the plan includes a switching plan to control which routes of the terminal are traveled on by rail vehicles, the switching plan including a schedule that identifies switches to be actuated, directions in which to actuate the switches, and times at which to actuate the switches.

14. The system of claim 9, wherein the one or more processors are configured to determine the plan to avoid a stack gap in a rail vehicle system that represents the second transportation vehicle.

15. The system of claim 9, wherein the one or more processors are configured to determine the plan based on a range of one or more cranes of the cargo handling equipment and a time period required for the one or more cranes to move the at least one cargo container.

16. The system of claim 9, wherein the one or more processors are configured to monitor each efficiency metric over time and assign a respective value for each of the efficiency metrics based on a tracked efficiency of the efficiency metric.

17. The system of claim 16, wherein the one or more processors are configured to modify the plan or generate a different plan based on the values assigned to the efficiency metrics.

18. The system of claim 9, wherein the one or more processors are configured to determine the plan to assign the first transportation vehicle to a first processing route of the routes for the cargo handling equipment to unload the at least one cargo container from the first transportation vehicle, and to assign the second transportation vehicle to a second processing route of the routes for the cargo handling equipment to load the at least one cargo container onto the second transportation vehicle.

19. A method comprising:
determining at least one characteristic of at least one cargo container that is scheduled for one or more of receipt into or travel out of a terminal, and the terminal is connected with different routes configured to accommodate a plurality of differing transportation vehicles;
determining at least one characteristic of cargo handling equipment associated with the terminal, the cargo handling equipment being selected from cranes, lifts, conveyors, and elevators;
determining at least one characteristic of a first transportation vehicle of the plurality of differing transportation vehicles that is scheduled for one or more of entry into or travel out of the terminal, and the first transportation vehicle being associated with a first mode of transportation;
determining at least one characteristic of a different, second transportation vehicle of the plurality of differing transportation vehicles that is scheduled for entry into or travel out of the terminal, and the second transportation vehicle being associated with a different, second mode of transportation;
determining at least one constraint associated with cargo handling operations involving transferring the at least one cargo container from the first mode of transportation to the second mode of transportation via the cargo handling equipment;
determining a plan for the cargo handling equipment to transfer the at least one cargo container between the first and second modes of transportation within the terminal based at least in part on the at least one characteristic of the at least one cargo container, the at least one characteristic of the cargo handling equipment, the at least one characteristic of the first transportation vehicle, the at least one characteristic of the second transportation vehicle, and the constraint associated with the cargo handling operations; and
initiating the cargo handling equipment to move the at least one cargo container to transfer the at least one cargo container from the first transportation vehicle to the second transportation vehicle according to the plan.

20. The method of claim 19, wherein the cargo handling equipment is initiated to move the at least one cargo container by generating a control signal to one or more of (i) remotely control the cargo handling equipment to move the at least one cargo container, or (ii) display instructions on a display device for viewing by an operator of the cargo handling equipment.
